(19) United States
(12) Patent Application Publication
(10) Pub. No.: US 2014/0340542 A1
(43) Pub. Date: Nov. 20, 2014

(54) ELECTRONIC DEVICE AND METHOD FOR DETECTING IMAGE CAPTURING FUNCTION

(71) Applicant: HON HAI PRECISION INDUSTRY CO., LTD., New Taipei (TW)

(72) Inventor: CHIEN-HAO TSENG, New Taipei (TW)

(73) Assignee: HON HAI PRECISION INDUSTRY CO., LTD., New Taipei (TW)

(21) Appl. No.: 14/279,332

(22) Filed: May 16, 2014

(30) Foreign Application Priority Data
May 17, 2013 (TW) 102117664

(51) Int. Cl. H04N 5/232; G06K 9/62; H04N 17/00

(52) U.S. Cl. CPC H04N 5/232; H04N 17/002; G06K 9/6202
USPC 348/222.1

(57) ABSTRACT

An electronic device with an image capturing device includes device to detect the functionality and quality of the image capturing device. Images of a first template object and of a different second template object are taken. The detecting device compares image of the first with a first predetermined standard image of the first template object to determine whether the first image possesses certain qualities and compares the image of the second with a second predetermined standard image of the second template object to determine whether the second image possesses the qualities and outputs a result indicating whether or not the image capturing device is acceptable based on whether the first and second images have the certain qualities.

### FIELD

The present disclosure relates to an electronic device and a method for detecting qualities for an image capturing function of the electronic device.

### BACKGROUND

An electronic device (e.g. a mobile phone or a table computer) may be provided with an image capturing device for capturing images.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an electronic device having an image capturing device.

FIG. 2 is a schematic block diagram of the electronic device of FIG. 1.

FIG. 3 is a flowchart of a method for detecting and assessing image capturing function of the electronic device using the functional modules of FIG. 2.

FIG. 4 is a detailed flowchart of block 14 of FIG. 3.

FIG. 5 is a detailed flowchart of block 16 of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

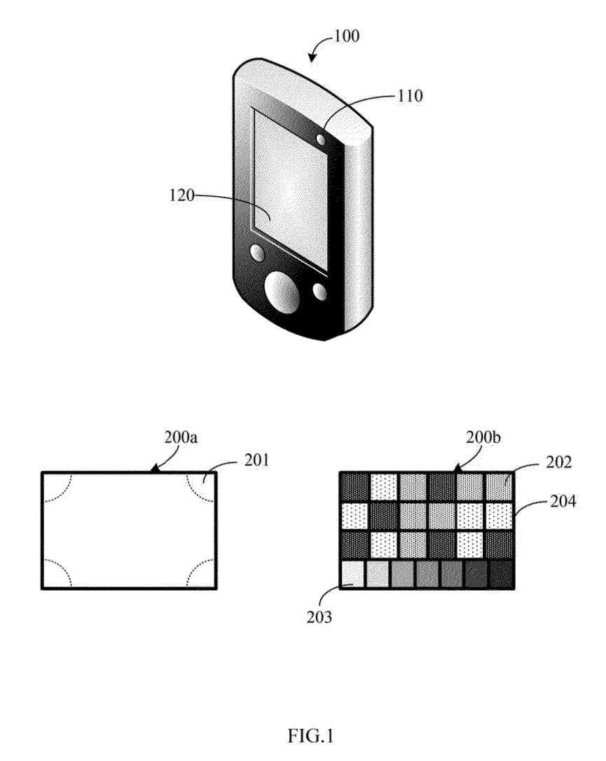

FIG. 1 is a diagram illustrating one embodiment of an electronic device 100 having an image capturing device 110 and a display 120. The image capturing device 110 is configured to capture images of a first template object 200a and a different second template object 200b. In the embodiment, the electronic device 100 can be a smart phone or a tablet computer, for example. The color of first template object 200a in this embodiment is white which is defined as a first feature of the first template object 200a. The second template object 200b in this embodiment is multicolored and includes a plurality of color blocks 202, a plurality of gray blocks 203, and a plurality of black borders 204 surrounding each color block 202 and each gray block 203, wherein the color blocks 202, the gray blocks 203 and the black borders 204 are defined as a paramount feature of the second template object 200b. FIG. 1 illustrates one embodiment of the electronic device 100, which can include more or fewer components than those shown in the embodiment, or have a different configuration of the components.

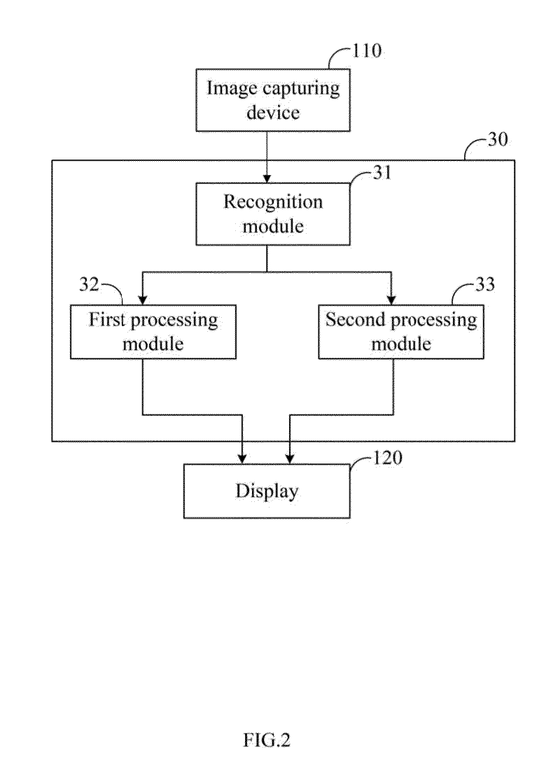

FIG. 2 is a block diagram of the electronic device 100 in FIG. 1. In the embodiment, the detecting device 10 includes a recognition module 31, a first processing module 32, and a second processing module 33. In general, the word “module,” as used herein, refers to logic embodied in hardware or firmware, or to a collection of software instructions written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

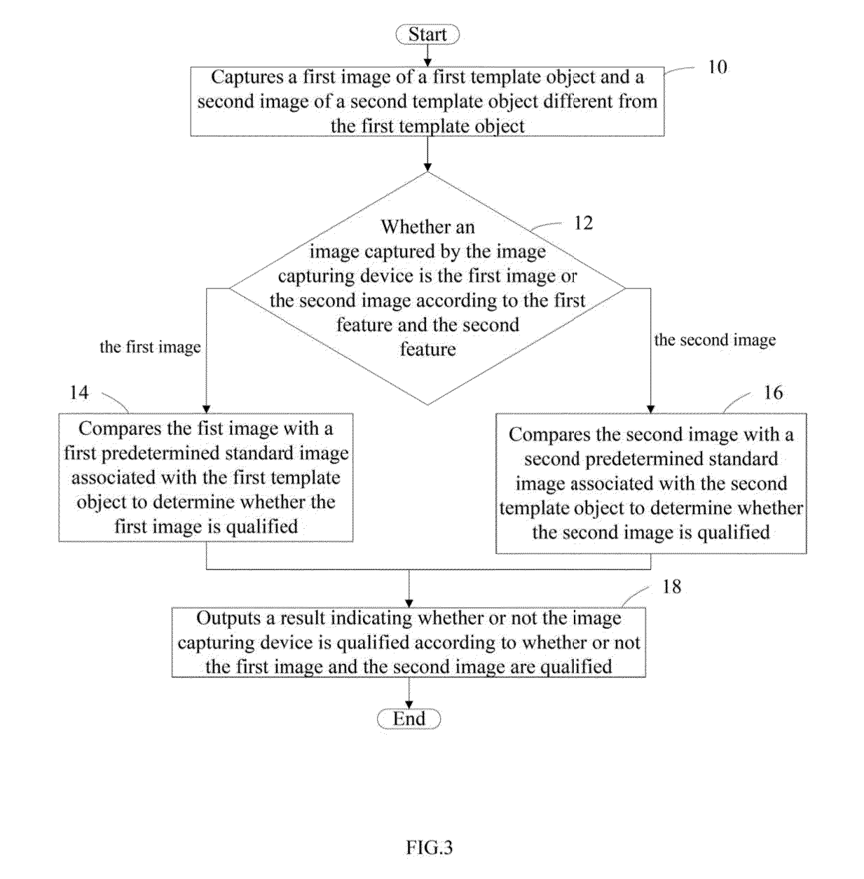

FIG. 3 illustrates a flowchart of one embodiment of a detecting method using the modules of the detecting device 10 of FIG. 2. Depending on the embodiment, additional steps may be added, others removed, and the ordering of the steps may be changed.

In block 10, the image capturing device 110 captures a first image of a first template object and a second image of a second template object of FIG. 1. The first image can include the first feature of the first template object 200a. The second image can include the paramount feature of the second template object 200b.

In block 12, the recognition module 31 recognizes whether an image captured by the image capturing device 110 is the first image or the second image according to the existence of the first feature and the paramount feature. In this embodiment, the recognition module 31 recognizes whether an image captured is a first image or a second image by searching for the black borders. When the recognition module 13 has not found black borders in the captured image, the captured image is determined to be the first image. When the recognition module 13 does see black borders in the captured image, the captured image is determined to be the second image. If the captured image is the first image, block 14 is implemented. If the captured image is the second image, block 16 is implemented.

In block 14, the first processing module 31 compares the first image with a first predetermined standard image associated with the first template object to determine whether the first image possesses certain qualities. The first predetermined standard image is obtained by capturing an image of the first template object using an image capturing device with recognized qualities, and the procedure goes to S18.

In block 16, the second processing module 32 compares the second image with a second predetermined standard image associated with the second template object to determine whether the second image possesses certain qualities. The second predetermined standard image is obtained by capturing an image of the second template object using the image capturing device with recognized qualities.

In block 18, the output module 33 outputs a result indicating whether or not the image capturing device 110 has functionality and is qualified according to certain standards depending on whether both of the first image and the second image possess the certain qualities or not. If both the first and second images possess the certain qualities, the functionality and performance of the image capturing device is determined to be acceptable.

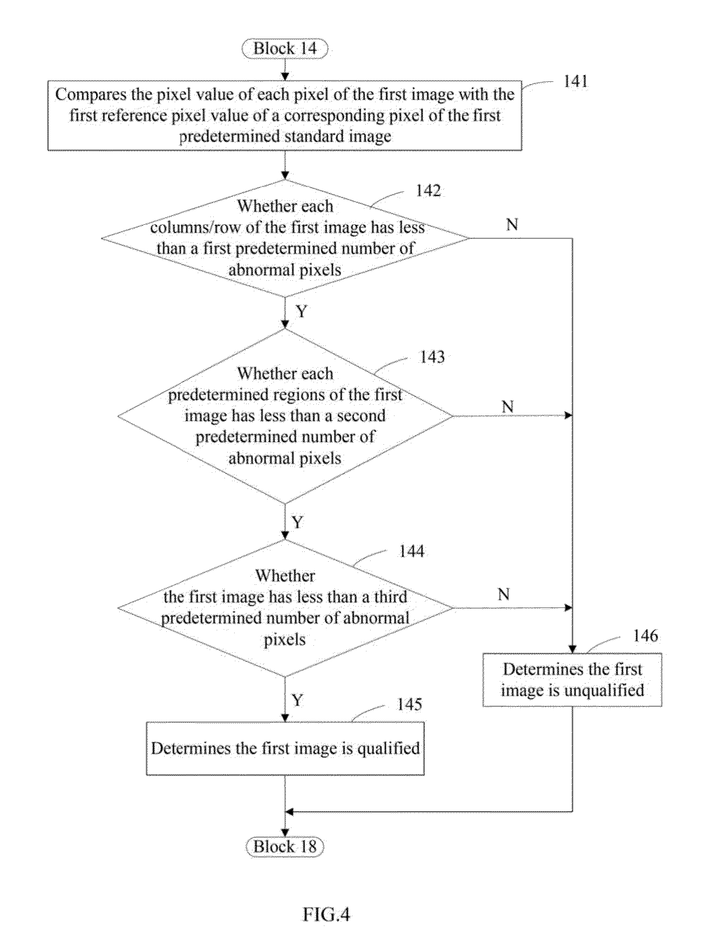

FIG. 4 is a detailed flowchart of block 14 in FIG. 3. Depending on the embodiment, additional steps may be added, others removed, and the ordering of the steps may be changed.

In this embodiment, each pixel of the first predetermined standard image has a first reference pixel value based on red, green, blue (RGB) color space.

In block 141, the first processing module 32 compares the pixel value of each pixel of the first image with the first reference pixel value of a corresponding pixel of the first predetermined standard image. The pixel value of the first image in this embodiment is based on the RGB color space. When a difference between the pixel value of a pixel of the first image and the first reference pixel value of a corresponding pixel of the first predetermined standard image is greater than a first predetermined value, the pixel of the first image is defined as being abnormal.

In block 142, the first processing module 32 determines whether each column/each row of the first image has less than a first predetermined number of abnormal pixels. If each column and row of the first image has less than the first predetermined number of abnormal pixels, S143 is implemented. If at least one column or row of the first image has more than the first predetermined number of abnormal pixels, S146 is implemented.

In block 143, the first processing module 32 determines whether each region of the first image has less than a second predetermined number of abnormal pixels, the one or more regions being predetermined in size and location. In the embodiment, the predetermined region can be a corner of the first image which includes a predetermined number of pixels. If every region of the first image has less than the second predetermined number of abnormal pixels, block 144 is implemented. If at least one region of the first image has more than a second predetermined number of abnormal pixels, block 146 is implemented.

In block 144, the first processing module 32 determines whether the first image has less than a third predetermined number of abnormal pixels. If the first image has less than the third predetermined number of abnormal pixels, block 145 is implemented, otherwise block 146 is implemented.

In block 145, the first processing module 32 determines that the first image possesses the certain qualities and the procedure goes to block 18.

In block 146, the first processing module 32 determines that the first image does not possess all the certain qualities and the procedure goes to block 18.

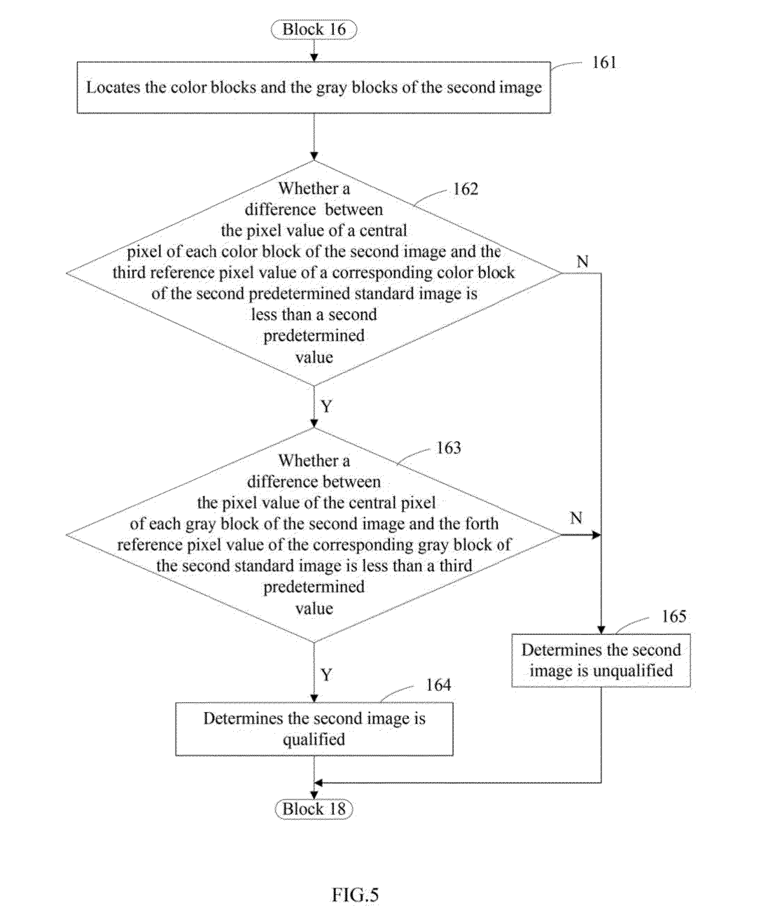

FIG. 5 is a detailed flowchart of block 16 in FIG. 3. Depending on the embodiment, additional steps may be added, others removed, and the ordering of the steps may be changed. In this embodiment, the second image and the second predetermined standard image each includes a plurality of color blocks and a plurality of gray blocks. Each color block of the second predetermined standard image has a third reference pixel value, and each gray block of the second predetermined standard image has a corresponding fourth reference pixel value. The third reference pixel value and the fourth reference pixel based on intensity, hue, saturation (IHS) color system. A central pixel of each color block of the second image and a central pixel of each gray block of the second image have a pixel value based on HIS color system.

In block 161, the second processing module 33 locates the color blocks and the gray blocks of the second image. In this embodiment, the second processing module 33 locates the color blocks and the gray blocks according to the black borders.

In block 162, the second processing module 33 compares the pixel value of a central pixel of each color block of the second image with the third reference pixel value of a corresponding color block of the second predetermined standard image. If a difference between the pixel value of the central pixel of each color block of the second image and the third reference pixel value of the corresponding color block of the second predetermined standard image is less than a second predetermined value, block 163 is implemented. If a difference between the pixel value of the central pixel of at least one color block of the second image and the third reference pixel value of the corresponding color block of the second predetermined standard image is equal to or greater than the second predetermined value, block 165 is implemented.

In block 163, the second processing module 33 compares the pixel value of the central pixel of each gray block of the second image with the fourth reference pixel value of a corresponding gray block of the second predetermined standard image. If a difference between the pixel value of the central pixel of each gray block of the second image and the fourth reference pixel value of the corresponding gray block of the second predetermined standard image is less than a third predetermined value, block 164 is implemented. If a difference between the pixel value of the central pixel of at least one gray block of the second image and the fourth reference pixel value of the corresponding gray block is equal to or greater than the third predetermined value, block 165 is implemented.

In block 164, the second processing module 33 determines that the second image possesses the certain qualities and the procedure goes to block 18.

In block 165, the second processing module 33 determines that the second image does not possess the certain qualities and the procedure goes to block 18.

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device, comprising:
an image capturing device for capturing a first image of a first template object and a second image of a second template object different from the first template object; and
a detecting device, comprising:
a first processing module, wherein the first processing module compares the first image with a first predetermined standard image associated with the first template object to determine whether the first image is qualified; and
a second processing module, wherein the second processing module compares the second image with a second predetermined standard image associated with the second template object to determine whether the second image is qualified; and
an output module, wherein the output module outputs a result indicating whether or not the image capturing device is qualified according to whether or not the first image and the second image are qualified.

2. The electronic device as claimed in claim 1, wherein the first predetermined standard image and the second predetermined standard image are obtained by capturing the first template object and the second template object using a qualified image capturing device.

3. The electronic device as claimed in claim 1, wherein the first template object comprises a first feature and the second template object comprises a second feature different from the first feature.

4. The electronic device as claimed in claim 3, wherein the detecting unit further comprises:
a recognition module for recognizing whether an image captured by the image capturing device is the first image or the second image according to the first feature and the second feature;
wherein when the capture image is the first image, the first processing module is activated to compare the captured image with the first predetermined standard image; and
when the capture image is the second image, the second processing module is activated to compare the captured image with the second predetermined standard image.

5. The electronic device as claimed in claim 1, wherein each pixel of the first predetermined standard image having a first reference pixel value, and each of the first reference pixel value is based on RGB color space.

6. The electronic device as claimed in claim 5, wherein the first processing module determines whether the first image is qualified by:
comparing the pixel value of each pixel of the first image with the first reference pixel value of a corresponding pixel of the first predetermined standard image; wherein when a difference between the pixel value of a pixel of the first image and the first reference pixel value of a corresponding pixel of the first predetermined standard image is greater than a first predetermined value, the pixel of the first image is defined as an abnormal pixel;
determining whether each of columns/rows of the first image has less than a first predetermined number of abnormal pixels;
determining whether each of one or more predetermined regions of the first image has less than a second predetermined number of abnormal pixels; and
determining whether the first image has less than a third predetermined number of abnormal pixels;
wherein when each column/row of the first image has less than the first predetermined number of abnormal pixels, each predetermined region of the first image has less than the second predetermined number of abnormal pixels, and when the first image has less than the third predetermined number of abnormal pixels, the first image is determined to be qualified.

7. The electronic device as claimed in claim 1, wherein the second image and the second predetermined standard image each comprises a plurality of color blocks and a plurality of gray blocks, each color block of the second predetermined standard image has a third reference pixel value, each gray block of the second predetermined standard image has a corresponding forth reference pixel value.

8. The electronic device as claimed in claim 7, wherein the second processing module determines whether the second image is qualified by:
comparing the pixel value of a central pixel of each color block of the second image with the third reference pixel value of a corresponding color block of the second predetermined standard image;
comparing the pixel value of the central pixel of each gray block of the second image with the forth reference pixel value of a corresponding gray block of the second predetermined standard image; and
wherein if a difference between the pixel value of the central pixel of each color block of the second image and the third reference pixel value of the corresponding color block of the second predetermined standard image is less than a second predetermined value, and a difference between the pixel value of the central pixel of each gray block of the second image and the forth reference pixel value of the corresponding gray block of the second predetermined standard image is less than the third predetermined value, the image is determined to be qualified.

9. The electronic device as claimed in claim 8, wherein the pixel value of the central pixel of the color block, the pixel value of the central pixel of the gray block, the third reference pixel value and the forth reference pixel value are based on intensity, hue, saturation (IHS) color system.

10. A method for detecting an image capturing function of an electronic device, the method comprising:
capturing a first image of a first template object and a second image of a second template object different from the first template object;
comparing the first image with a first predetermined standard image associated with the first template object to determine whether the first image is qualified; and
comparing the second image with a second predetermined standard image associated with the second template object to determine whether the second image is qualified; and
outputting a result indicating whether or not the image capturing device is qualified according to whether or not the first image and the second image are qualified.

11. The method as claimed in claim 10, wherein the first predetermined standard image and the second predetermined standard image are obtained by capturing the first template object and the second template object using a qualified image capturing device.

12. The method as claimed in claim 10, wherein the first template object comprises a first feature and the second template object comprises a second feature different from the first feature.

13. The method as claimed in claim 12, further comprising:
recognizing whether an image captured by the image capturing device is the first image or the second image according to the first feature and the second feature;
wherein when the capture image is the first image, the captured image is compared with the first predetermined standard image; and
when the capture image is the second image, the captured image is compared with the second predetermined standard image.

14. The method as claimed in claim 1, wherein each pixel of the first predetermined standard image having a first reference pixel value, each pixel of the second predetermined standard image having a second reference pixel value, and each of the first and second reference pixel value is based on RGB color space.

15. The method as claimed in claim 14, wherein whether the first image is qualified is determined by:
comparing the pixel value of each pixel of the first image with the first reference pixel value of a corresponding pixel of the first predetermined standard image; wherein when a difference between the pixel value of a pixel of the first image and the first reference pixel value of a corresponding pixel of the first predetermined standard image is greater than a first predetermined value, the pixel of the first image is defined as an abnormal pixel;
determining whether each of columns/rows of the first image has less than a first predetermined number of abnormal pixels;
determining whether each of one or more predetermined regions of the first image has less than a second predetermined number of abnormal pixels; and
determining whether the first image has less than a third predetermined number of abnormal pixels;
wherein when each column/row of the first image has less than the first predetermined number of abnormal pixels, when each predetermined region of the first image has less than the second predetermined number of abnormal pixels, and when the first image has less than the third predetermined number of abnormal pixels, the first image is determined to be qualified.

16. The method as claimed in claim 10, wherein the second image and the second predetermined standard image each comprises a plurality of color blocks and a plurality of gray blocks, each color block of the second predetermined standard image has a third reference pixel value, each gray block of the second predetermined standard image has a corresponding forth reference pixel value.

17. The method as claimed in claim 16, wherein whether the second image is qualified is determined by:
comparing the pixel value of a central pixel of each color block of the second image with the third reference pixel value of a corresponding color block of the second predetermined standard image;
comparing the pixel value of the central pixel of each gray block of the second image with the forth reference pixel value of a corresponding gray block of the second predetermined standard image; and
wherein if a difference between the pixel value of the central pixel of each color blocks of the second image and the third reference pixel value of the corresponding color block of the second predetermined standard image is less than a second predetermined value, and a difference between the pixel value of the central pixel of each gray blocks of the second image and the forth reference pixel value of the corresponding gray block is less than the third predetermined value, the second image is determined to be qualified.

18. The method as claimed in claim 17, wherein the pixel value of the central pixel of the color block, the pixel value of the central pixel of the gray block, the third reference pixel value and the forth reference pixel value are based on IHS color system.
